(19) United States
(12) Patent Application Publication
(10) Pub. No.: US 2025/0332638 A1
(43) Pub. Date: Oct. 30, 2025

(54) ULTRAFAST LASER SHOCK FORGING ASSISTED LASER POWDER BED FUSION (LPBF) METHOD CAPABLE OF CONTROLLING STRESS FIELD FOR ADDITIVE-MANUFACTURED COMPONENT

(71) Applicant: Air Force Engineering University, Xi'an (CN)

(72) Inventors: Liucheng Zhou, Xi'an (CN); Xinlei Pan, Xi'an (CN); Weifeng He, Xi'an (CN)

(21) Appl. No.: 18/767,740

(22) Filed: Jul. 9, 2024

(30) Foreign Application Priority Data
Apr. 29, 2024 (CN) 20210532572.8

(51) Int. Cl. B22F 10/31; B22F 10/28; B22F 10/34; B22F 10/68; B22F 10/85; B22F 12/45; B22F 12/49; B22F 12/67; B22F 12/90; B23K 26/342; B33Y 10/00; B33Y 30/00; B33Y 40/20; B33Y 50/02

(52) U.S. Cl. CPC B22F 10/31; B22F 10/28; B22F 10/34; B22F 10/68; B22F 10/85; B22F 12/45; B22F 12/49; B22F 12/67; B22F 12/90; B23K 26/342; B33Y 10/00; B33Y 30/00; B33Y 40/20; B33Y 50/02; B22F 2998/10

(57) ABSTRACT

Provided is an ultrafast laser shock forging assisted laser powder bed fusion (LPBF) method with an ultrafast laser to allow on-line control of a stress field for an additive-manufactured component. Technical points of the present disclosure: During a LPBF-based additive manufacturing process, ultra-high-pressure shock waves induced byan ultrafast laser are allowed to forge a molten layer on-line, and a stress field distribution of a molten layer can be accurately controlled layer by layer, so as to reduce a residual stress level of an additive-manufactured component and improve the mechanical properties of an additive-manufactured component, thereby allowing the high-performance LPBF-based additive manufacturing. The present disclosure has the following advantages: Due to the layer-by-layer shock forging mode, the method can control a stress field with a high accuracy and a better effect, will not cause secondary pollution or destruction, and exhibits excellent technical applicability.

### CROSSREFERENCE TO RELATED APPLICATION

This application claims priority to Chinese Patent Application No. 202410532572.8, titled “ULTRAFAST LASER SHOCK FORGING ASSISTED LASER POWDER BED FUSION (LPBF) METHOD CAPABLE OF CONTROLLING STRESS FIELD FOR ADDITIVE-MANUFACTURED COMPONENT” and filed to the China National Intellectual Property Administration on Apr. 29, 2024, the entire contents of which are incorporated herein by reference.

### TECHNICAL FIELD

The present disclosure relates to the technical field of additive manufacturing, and specifically to an ultrafast laser shock forging assisted laser powder bed fusion (LPBF) method capable of controlling a stress field for an additive-manufactured component.

### BACKGROUND

The laser powder bed fusion (LPBF) technology is increasingly used for the fabrication of complicated structural parts due to its excellent flexibility and high forming accuracy. During an LPBF process, due to an instantaneous extremely-high heat input and a locally-high temperature gradient, a tensile residual stress is inevitably introduced into a forming component, and with the increase of a size of the forming component, a thermal effect continues to accumulate, such that defects such as pores and cracks, easily occur, which results in the reduction of mechanical properties of the forming component and seriously restricts the development of LPBF technology.

In the existing thermal treatment-based stress release methods, a residual stress field inside a material can hardly be controlled, and the addition of an external heat source is easy to cause the deformation of a component, resulting in some limitations.

### SUMMARY

In view of the deficiencies in the art, an objective of the present disclosure is to provide an ultrafast laser shock forging assisted LPBF method capable of controlling a stress field for an additive-manufactured component. The ultrafast laser shock forging assisted LPBF method has the following advantage: ultra-high-pressure shock waves induced by ultrafast laser is used to forge the molten layer on-line, thereby achieving he high-performance LPBF-based additive manufacturing.

The above objective of the present disclosure is allowed by the following technical solutions:

An ultrafast laser shock forging assisted LPBF method capable of controlling a stress field for an additive-manufactured component is provided, where
the ultrafast laser shock forging assisted LPBF method involves a workbench, where a nanosecond laser and an ultrafast laser are provided on the workbench, a scanning galvanometer used for nanosecond laser is connected to a side of the nanosecond laser, a scanning galvanometer used for ultrafast laser is connected to a side of the ultrafast laser, an image recognition system and a monitoring system are further provided at a side of the workbench, and the nanosecond laser, the ultrafast laser, the scanning galvanometer used for nanosecond laser, the scanning galvanometer used for ultrafast laser, the image recognition system, and the monitoring system all are connected to a central controller; and
a method for on-line control of the stress field for the additive-manufactured component with the ultrafast laser includes the following steps:
S1, setting parameters of the nanosecond laser and parameters of the ultrafast laser, planning paths for two laser beams with path filling software, and saving parameters for the two laser beams and path-planning files;
S2, starting and debugging a powder bed device, and importing, saving, and backing up a slicing file;
S3, turning on a switch of an argon cylinder, waiting for the parameter of an atmosphere, a substrate temperature, a blower system, and a laser to be met;
S4, adjusting the moving parameter of a substrate to meet a layer thickness set in a slicing file, scrape-recovering excess powders by a scraper, and starting both the scanning galvanometer used for nanosecond laser and the scanning galvanometer used for ultrafast laser, such that the nanosecond laser and the ultrafast laser start to work. During the process, the ultrafast laser follows the nanosecond laser in-situ. In this way, the current solidified layer is forged by ultrahigh pressure shock wave induced by ultrafast laser.
S5, repeating the S3, spreading a powder with a powder-spreading device, and allowing the nanosecond laser and the ultrafast laser to work at the time interval to allow ultrafast laser shock forging assisted LPBF of the next layer; and repeating the above process until all layers are printed;
S6, when the image recognition system and the monitoring system recognize that the shock forging is completed, sending a stop signal to the central controller, such that each subsystem stops working, and ultrafast laser shock forging assisted LPBF is finished; and
S7, after the additive-manufactured component is printed, closing the argon cylinder, and after an air pressure and the atmosphere in the printing chamber return to normal levels, opening a chamber door, removing the substrate, conducting wire cutting to obtain a sample, taking the sample out, and polishing and post-treating the sample.

In a preferred embodiment, the present disclosure can be further configured as follows: The debugging in the S2 is as follows: adjusting a position of the substrate on the workbench with a level ruler, adjusting a state of the scraper, and debugging powder-spreading.

In a preferred embodiment, the present disclosure can be further configured as follows: The S4 specifically includes:
starting melting by the nanosecond laser according to a preset path and laser parameters, and allowing rapid solidification to form a metallurgical bonding layer; and
when the image recognition system and the monitoring system recognize that the nanosecond laser starts to work, sending a start signal for ultrafast laser shock forging by the central controller to the ultrafast laser and the scanning galvanometer used for ultrafast laser to allow ultrafast laser shock forging for the current layer, and after the ultrafast laser shock forging is completed, entering a standby state.

In a preferred embodiment, the present disclosure can be further configured as follows: The time interval between the ultrafast laser and the nanosecond laser is 0.5 s to 5 s, and is adjusted at any time according to scanning speeds of the two laser beams, such that the time of ultrafast laser shock forging could be set more flexibly.

In a preferred embodiment, the present disclosure can be further configured as follows: A scanning path of the nanosecond laser is directional light and a scanning path of the ultrafast laser is in a “Z” shape.

In a preferred embodiment, the present disclosure can be further configured as follows: In the S7, powders on the substrate and in a material mixing tank are collected, sieved through a sifting machine to remove impurities, and then saved.

In a preferred embodiment, the present disclosure can be further configured as follows: During an ultrafast laser shock forging assisted LPBF process, in addition to recognizing ultrafast laser shock forging assisted LPBF start and end signals, the image recognition system and the monitoring system monitor working states of the two laser beams and quality states of a melt pool and a printing surface; and when there is an error in scanning paths of the two laser beams, a substantial splash of the melt pool, or a large-size defect, an alarm and a record are made and printing is stopped.

In summary, the present disclosure includes at least one of the following beneficial technical effects:

A stress field can be controlled during a LPBF-based additive manufacturing process. Due to a layer-by-layer ultrafast laser shock forging mode, the method can control a stress field with a higher accuracy and a better effect, will not cause secondary pollution or destruction, and exhibits excellent technical applicability. Therefore, the present disclosure can solve problems such as cracking and deformation caused by a too-high tensile residual stress, and allows the high-performance manufacturing of an additive-manufactured component.

### BRIEF DESCRIPTION OF THE DRAWINGS

FIG. 1 is a technical schematic diagram of the present disclosure;

FIG. 2 is a schematic flow chart of the present disclosure;

FIG. 3 is a comparison diagram of residual stress in depth of 7075 aluminum alloy samples manufactured by the ultrafast laser shock forging assisted LPBF in the present disclosure and LPBF;

FIG. 4 is a comparison diagram of residual stress in depth of 316L stainless steel samples manufactured by the ultrafast laser shock forging assisted LPBF in the present disclosure and LPBF; and

FIG. 5 is a comparison histogram of surface residual surface stress of 316L stainless steel samples manufactured by the ultrafast laser shock forging assisted LPBF in the present disclosure and LPBF.

Reference numerals: 1: workbench, 2: nanosecond laser, 3: scanning galvanometer used for nanosecond laser, 4: scanning galvanometer used for ultrafast laser, 5: ultrafast laser, 6: image recognition system, and 7: monitoring system.

### DETAILED DESCRIPTION OF THE EMBODIMENTS

The present disclosure is further described in detail below with reference to the accompanying drawings.

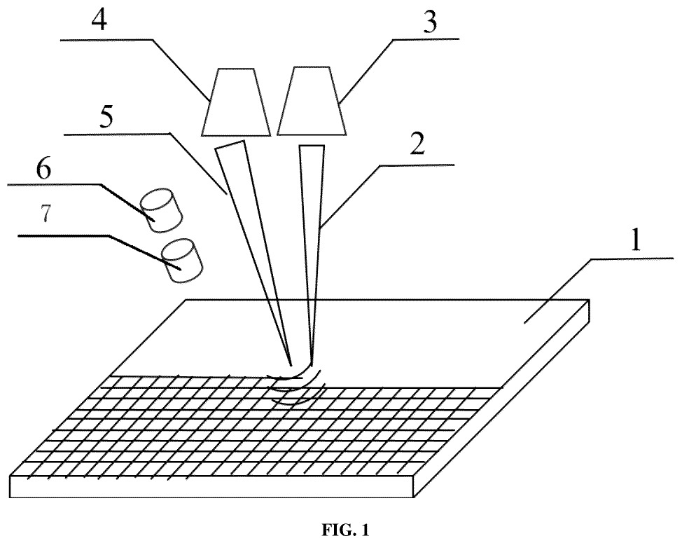

As shown in FIG. 1, the ultrafast laser shock forging assisted LPBF method capable of controlling a stress field for an additive-manufactured component disclosed in the present disclosure involves a workbench 1. The workbench 1 not only includes a countertop of the workbench 1, but also includes other devices corresponding to the workbench 1, which are not repeated here. A substrate is placed on the workbench 1, and a nanosecond laser 2 and an ultrafast laser 5 are provided on the workbench 1. The nanosecond laser 2 and the ultrafast laser 5 here also include devices used thereby correspondingly. A scanning galvanometer 3 used for nanosecond laser is connected to a side of the nanosecond laser 2, a scanning galvanometer 4 used for ultrafast laser is connected to a side of the ultrafast laser 5, and an image recognition system 6 and a monitoring system 7 are further provided at a side of the workbench 1. The nanosecond laser 2, the ultrafast laser 5, the scanning galvanometer 3 used for nanosecond laser, the scanning galvanometer 4 used for ultrafast laser, the image recognition system 6, and the monitoring system 7 all are connected to a central controller. The above components are controlled by the central controller.

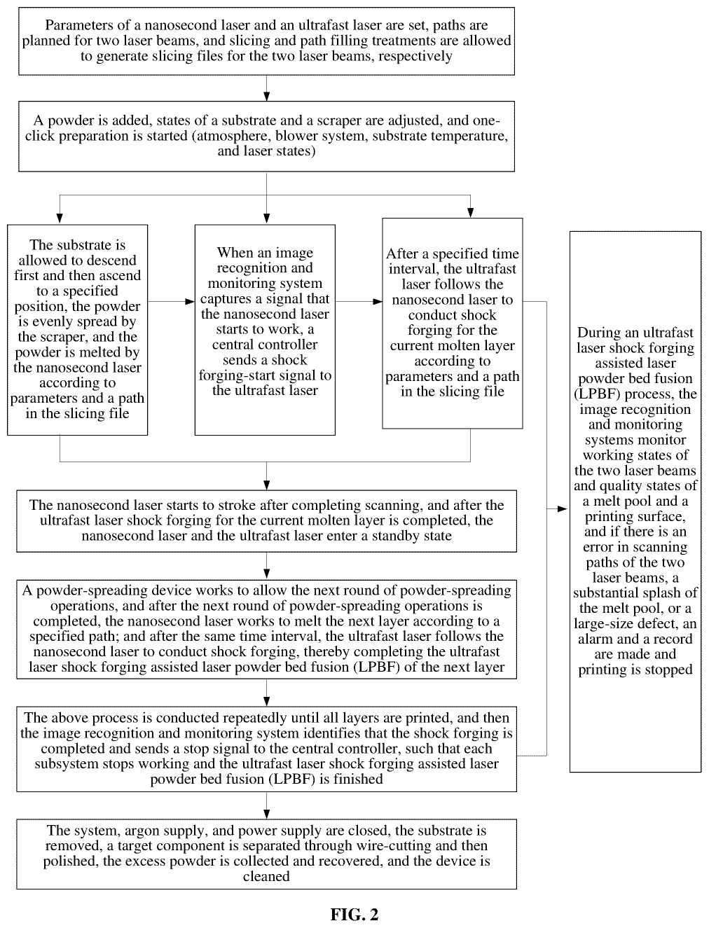

As shown in FIG. 2, a method for on-line control of the stress field for the additive-manufactured component with the ultrafast laser 5 includes the following steps:

(1) With a 7075 aluminum alloy material as an example:

S1, Parameters of the nanosecond laser 2 and parameters of the ultrafast laser 5 are set as follows:

According to a melting point (475° C. to 635° C.) of a 7075 aluminum alloy, a temperature of a melt pool is set to 700° C., which is based on a principle of effectively controlling defects such as cracks and pores.

The parameters of the nanosecond laser 2 are set in the following ranges: a spot diameter: 80 μm to 100 μm; a laser power: 250 W to 400 W; a scanning speed: 500 mm/s to 1,400 mm/s; a layer thickness: 40 μm to 80 μm; a line spacing: 100 μm to 150 μm; and a substrate temperature: 200° C. to 300° C. The scanning path of the nanosecond laser is directional light and rotates by 45° to 75° layer by layer to avoid the deformation caused by heat accumulation at a same position.

The tensile residual stress of a LPBF-ed 7075 aluminum alloy sample is usually 50 MPa to 100 MPa. Theparameters of the ultrafast laser and an action range of a shock wave pressure induced by the ultrafast laser 5 are further set to effectively remove a tensile residual stress inside an additive-manufactured component. The parameters of the ultrafast laser 5 are set in the following ranges: a wavelength: 1,030 nm; a pulse duration: 200 fs to 600 fs; a power: 20 W to 50 W; laser energy: 200 μJ to 800 μJ; a scanning speed: 500 mm/s to 1,500 mm/s; a repetition frequency: 50 kHz to 100 kHz; a spot diameter: 40 μm to 80 μm; overlapping: 33% to 67%; and a scanning path: a “Z” shape.

A slicing treatment is conducted according to size characteristics of the target component, and then paths for the two laser beams are planned with path filling software to ensure that the ultrafast laser 5 always moves following the nanosecond laser at a specified interval. As a result, scanning parameters and path-planning files for the nanosecond laser 2 and the ultrafast laser 5 are generated and saved, respectively.

S2, A prepared powder is added to a powder bin, a powder bed device is started, a position of the substrate on a surface of the workbench 1 is adjusted with a level ruler, a state of a scraper is adjusted, powder-spreading is debugged, and then a chamber door is closed. Control software of the powder bed device is opened, and a slicing file is imported, saved, and backed up.

S3, A switch of an argon cylinder is turned on. An atmosphere, a substrate temperature, a blower system, and a laser in a printing chamber are to meet standards of ultrafast laser shock forging assisted LPBF to complete a preparation work.

S4, The substrate is adjusted as follows: the substrate is allowed to first descend and then ascend to meet a layer thickness set in a slicing file. Then excess powders are scrape-recovered by the scraper to recover powders outside the forming substrate into an excess material tank.

The scanning galvanometer 3 used for nanosecond laser is started, melting is started by the nanosecond laser 2 according to a path and laser parameters preset in a slicing file, and rapid solidification is allowed to form a metallurgical bonding layer.

When the image recognition system 6 and the monitoring system 7 capture a signal that the nanosecond laser starts to work, a forging-start signal is sent by the central controller to the ultrafast laser 2 and the corresponding scanning galvanometer.

The nanosecond laser 2 and the scanning galvanometer 4 used for ultrafast laser start to work, and the ultrafast laser 5 and the nanosecond laser 2 are used at a time interval. The time interval is 0.5 s to 5 s, and is adjusted at any time according to scanning speeds of the two laser beams, such that scanning of the ultrafast laser 5 and scanning of the nanosecond laser 2 for a same region are completed simultaneously as much as possible.

The ultrafast laser 5 conduct shock forging for the current solidified layer according to parameters and paths in a slicing file.

Finally, the nanosecond laser 2 strokes after melting all regions of the current layer according to a specified path, and after the stroke is finished and the ultrafast laser shock forging for the current solidified layer is completed, the nanosecond laser and the ultrafast laser 5 enter a standby state.

S5, The S3 is repeated, the next round of powder-spreading is conducted with a powder-spreading device, the nanosecond laser 2 continues to work to scan and melt the next layer according to a specified path, and the ultrafast laser 5 works at the same interval together with the nanosecond laser 2 to allow shock forging, thereby completing the ultrafast laser shock forging assisted LPBF of the next layer. The above process is repeated until all layers are printed.

S6, When the image recognition system 6 and the monitoring system 7 recognize that the shock forging is completed, a stop signal is sent to the central controller, such that each subsystem stops working and ultrafast laser shock forging assisted LPBF is finished.

During an ultrafast laser shock forging assisted LPBF process, in addition to recognizing ultrafast laser shock forging assisted LPBF-start and -end signals, the image recognition system 6 and the monitoring system 7 monitor working states of the two laser beams and quality states of a melt pool and a printing surface; and when there is an error in scanning paths of the two laser beams, a substantial splash of the melt pool, or a large-size defect, an alarm and a record are made and printing is immediately stopped, thereby ensuring a quality of the ultrafast laser shock forging assisted LPBF process.

S7, After the additive-manufactured component is formed, the argon cylinder is closed, and after an air pressure and the atmosphere in the printing chamber return to normal levels, a chamber door is opened, the substrate is removed, wire cutting is conducted to obtain a sample, and the sample is taken out, polished, and post-treated.

Then, powders on the substrate and a material mixing tank are collected, sieved through a sifting machine to remove impurities, and then saved.

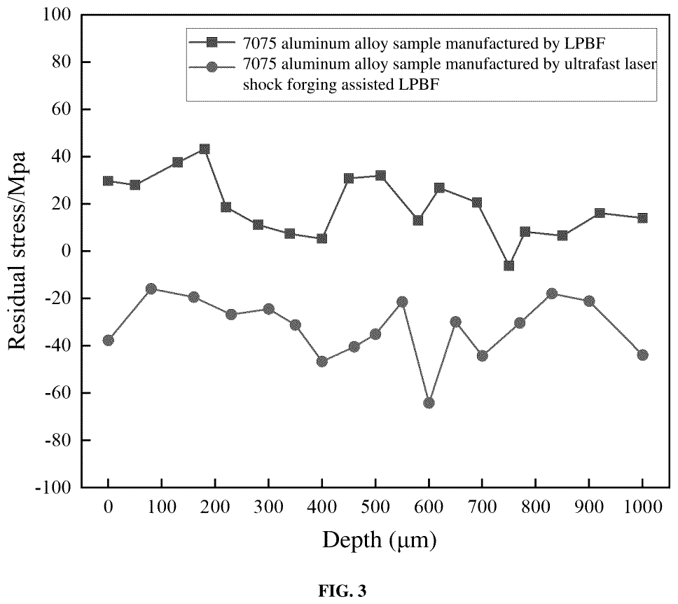

As shown in FIG. 3, X-rays are used to measure the residual stress of the forming components. FIG. 3 shows test results of residual stresses of 7075 aluminum alloy samples manufactured by ultrafast laser shock forging assisted LPBF and LPBF.

It can be seen from this figure that the surface and inside the 7075 aluminum alloy sample by LPBF is tensile residual stress (20 MPa to 40 MPa). But for the ultrafast laser shock forging assisted LPBF-ed samples, it is converted into tensile residual stress (−20 MPa to −40 MPa), indicating the effective control of a residual stress field by the method proposed in the presented disclosure.

(2) With a 316L stainless steel material as an example, the effectiveness of the ultrafast laser shock forging assisted LPBF method combining the ultrafast laser 5 and the nanosecond laser proposed in the present disclosure to control a stress field is further verified.

Because a melting point of the 316L stainless steel is 1,375° C. to 1,400° C., a temperature of a melt pool is set at 1,400° C. Parameters are optimized according to defects such as cracks and pores of a sample.

For the 316L stainless steel, the parameters of the nanosecond laser 2 are set in the following ranges: a spot diameter: 80 μm to 100 μm; a laser power: 300 W to 500 W; a scanning speed: 600 mm/s to 1,200 mm/s; a layer thickness: 40 μm to 60 μm; a line spacing: 100 μm to 150 μm; and a substrate temperature: 40° C. to 80° C. The scanning path of the nanosecond laser is directional light and rotates by 45° to 75° layer by layer to avoid the heat accumulation at a same position.

The 316L stainless steel LPBF-ed sample has a larger tensile residual stress of 400 MPa to 500 MPa, and thus it is necessary to increase the energy of the ultrafast laser 5. During the ultrafast laser shock forging assisted LPBF of the 316L stainless steel, parameters are the same as those for the 7075 aluminum alloy except that the energy of the ultrafast laser 5 increases to 400 μJ to 800 μJ.

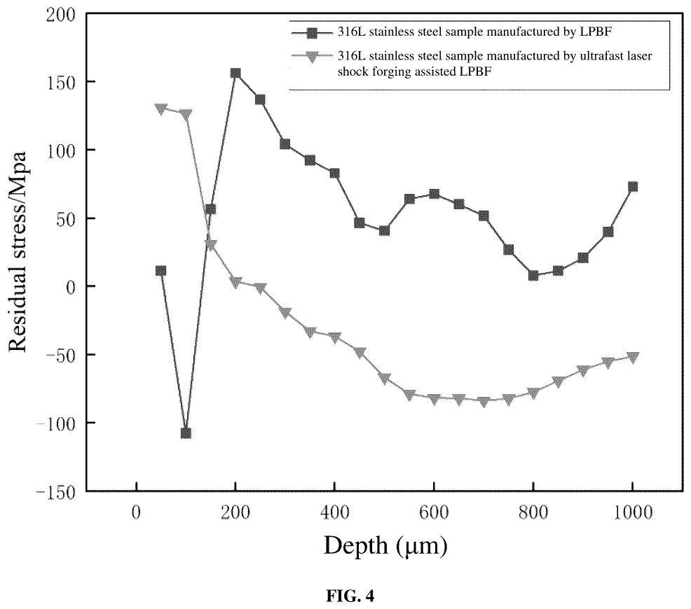

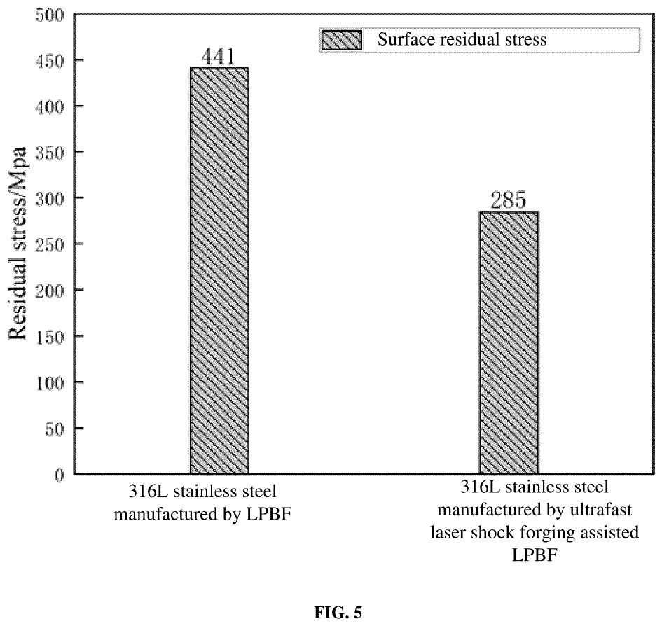

The subsequent slicing, ultrafast laser shock forging assisted LPBF, and post-treating steps all are the same as those for the 7075 aluminum alloy, which will not be repeated here. FIG. 4 and FIG. 5 are comparison diagrams of residual stresses of 316L stainless steel samples printed by the ultrafast laser shock forging assisted LPBF and the LPBF. It can be seen that the ultrafast laser shock forging assisted LPBF method proposed in the present disclosure is also applicable to the 316L stainless steel, and compared with a sample manufactured by LPBF, the residual stress on the surface of ultrafast laser shock forging assisted LPBF-ed sample is decreases from 441 MPa to 285 MPa. With the increase of a depth, it is gradually converted into compressive residual stress (50 MPa to 100 MPa).

The above results show that the technology provided in the technical solutions has excellent applicability and can be applicable to a variety of materials. The above specific embodiments all are preferred embodiments of the present disclosure, but the protection scope of the present disclosure is not limited thereto. Therefore, all equivalent changes made in accordance with the structure, shape, and principle of the present disclosure shall fall within the protection scope of the present disclosure.

What is claimed is:

1. An ultrafast laser shock forging assisted laser powder bed fusion (LPBF) method capable of controlling a stress field for an additive-manufactured component, wherein
the ultrafast laser shock forging assisted LPBF method involves a workbench (1), wherein a nanosecond laser (2) and an ultrafast laser (5) are provided on the workbench (1), a scanning galvanometer (3) used for nanosecond laser is connected to a side of the nanosecond laser (2), a scanning galvanometer (4) used for ultrafast laser is connected to a side of the ultrafast laser (5), an image recognition system (6) and a monitoring system (7) are further provided at a side of the workbench (1), and the nanosecond laser (2), the ultrafast laser (5), the scanning galvanometer (3) used for nanosecond laser, scanning galvanometer (4) used for ultrafast laser, the image recognition system (6), and the monitoring system (7) all are connected to a central controller; and
a method for on-line control of the stress field for the additive-manufactured component with the ultrafast laser (5) comprises the following steps:
S1, setting parameters of the nanosecond laser (2) and parameters of the ultrafast laser (5), planning paths for two laser beams with path filling software, and saving parameters for the two laser beams and path-planning files;
S2, starting and debugging a powder bed device, and importing, saving, and backing up a slicing file;
S3, turning on a switch of an argon cylinder, waiting for an atmosphere, a substrate temperature, a blower system, and a laser in a printing chamber to be met standards;
S4, adjusting moving parameters of a substrate to meet a layer thickness set in a slicing file, scrape-recovering excess powders by a scraper, and starting both the scanning galvanometer (3) used for nanosecond laser and the scanning galvanometer (4) used for ultrafast laser, such that the nanosecond laser (2) and the ultrafast laser (5) start to work at a time interval;
S5, repeating the S3, spreading a powder with a powder-spreading device, and allowing the nanosecond laser (2) and the ultrafast laser (5) to work at the time interval to allow ultrafast laser shock forging assisted LPBF of the next layer; and repeating the above process until all layers are printed;
S6, when the image recognition system (6) and the monitoring system (7) recognize that the shock forging is completed, sending a stop signal to the central controller, such that each subsystem stops working, and ultrafast laser shock forging assisted LPBF is finished; and
S7, after the additive-manufactured component is printed, closing the argon cylinder, and after an air pressure and the atmosphere in the printing chamber return to normal levels, opening a chamber door, removing the substrate, conducting wire cutting to obtain a sample, taking the sample out, and polishing and post-treating the sample.

2. The ultrafast laser shock forging assisted LPBF method capable of controlling a stress field for an additive-manufactured component according to claim 1, wherein the debugging in the S2 is as follows: adjusting a position of the substrate on the workbench (1) with a level ruler, adjusting a state of the scraper, and debugging powder-spreading.

3. The ultrafast laser shock forging assisted LPBF method capable of controlling a stress field for an additive-manufactured component according to claim 2, wherein the S4 specifically comprises:
starting melting by the nanosecond laser (2) according to a preset path and laser parameters, and allowing rapid solidification to form a metallurgical bonding layer; and
when the image recognition system (6) and the monitoring system recognize that the nanosecond laser (2) starts to work, sending a start signal for ultrafast laser shock forging by the central controller to the ultrafast laser (5) and the scanning galvanometer (4) used for ultrafast laser to allow ultrafast laser shock forging for the current layer, and after the ultrafast laser shock forging is completed, entering a standby state.

4. The ultrafast laser shock forging assisted LPBF method capable of controlling a stress field for an additive-manufactured component according to claim 3, wherein the time interval between the ultrafast laser (5) and the nanosecond laser (2) is 0.5 s to 5 s, and is adjusted at any time according to scanning speeds of the two laser beams, such that a time of ultrafast laser shock forging is set more flexibly.

5. The ultrafast laser shock forging assisted LPBF method capable of controlling a stress field for an additive-manufactured component according to claim 4, wherein a scanning path of the nanosecond laser (2) is directional light and a scanning path of the ultrafast laser (5) is in a “Z” shape.

6. The ultrafast laser shock forging assisted LPBF method capable of controlling a stress field for an additive-manufactured component according to claim 1, wherein in the S7, powders on the substrate and a material mixing tank are collected, sieved through a sifting machine to remove impurities, and then saved.

7. The ultrafast laser shock forging assisted LPBF method capable of controlling a stress field for an additive-manufactured component according to claim 1, wherein during an ultrafast laser shock forging assisted LPBF process, in addition to recognizing ultrafast laser shock forging assisted LPBF start and end signals, the image recognition system and the monitoring system monitor working states of the two laser beams and quality states of a melt pool and a printing surface; and when there is an error in scanning paths of the two laser beams, a substantial splash of the melt pool, or a large-size defect, an alarm and a record are made and printing is stopped.
